(19) United States
(12) Patent Application Publication
(10) Pub. No.: US 2021/0320997 A1
(43) Pub. Date: Oct. 14, 2021

(54) INFORMATION PROCESSING DEVICE, INFORMATION PROCESSING METHOD, AND INFORMATION PROCESSING PROGRAM

(71) Applicant: SONY CORPORATION, TOKYO (JP)

(72) Inventors: TOMOTAKA TAKEMURA, TOKYO (JP); HIDEKI SHIMOJIMA, TOKYO (JP); KEIKO KITAYAMA, TOKYO (JP)

(21) Appl. No.: 17/250,354

(22) PCT Filed: Jun. 24, 2019
(86) PCT No.: PCT/JP2019/024863

§ 371 Date: Jan. 8, 2021

(30) Foreign Application Priority Data
Jul. 19, 2018 (JP) 2018-136171

(51) Int. Cl. H04M 3/436; H04M 1/66; G10L 15/18; G10L 15/183

(52) U.S. Cl. CPC H04M 3/4365; H04M 1/66; H04M 2203/6027; G10L 15/183; G10L 15/1822

(57) ABSTRACT

An information processing device (100) includes: a first acquisition unit (141) that acquires speech with which region information indicating a predetermined region and intention information indicating a caller intention are associated; and a generation unit (142) that generates a speech determination model for determining the intention information of speech constituting a processing object on the basis of the speech acquired by the first acquisition unit (141) and the region information associated with the speech.

### FIELD

The present disclosure relates to an information processing device, an information processing method, and an information processing program. More precisely, the present disclosure relates to processing to generate a speech determination model for determining speech attributes and to processing to determine speech attributes using the speech determination model.

### BACKGROUND

As networks have developed, technology has been adopted for analyzing email sent by a user or character strings in which units of speech of the user are recognized, and so forth.

For example, technology is known that determines whether an optional email recipient is appropriate by learning the relationship between a character string contained in the email and a recipient address. Furthermore, technology is known that estimates attribute information of an optional symbol string by learning the relationship between a message or call, or the like, from a user and attribute information thereof, and that estimates the intention of the user sending the optional symbol string.

### CITATION LIST

### Patent Literature

Patent Literature 1: JP 2008-123318 A
Patent Literature 2: JP 2012-22499 A

### SUMMARY

### Technical Problem

Here, there is room for improvement with the foregoing prior art. For example, in the case of the prior art, the relationship between a character string contained in an email or a character string in which a unit of speech is recognized, or the like, and attribute information associated with the character string is learned.

However, in the case of a unit of speech of a telephone call or the like, for example, the utterance content may be different even for the same attribute information or the attribute information may differ even for similar utterance content, depending on the situation of the call recipient or the caller. That is, it may sometimes be difficult to improve determination accuracy only by using a target for determination to uniformly learn the relationship between speech and attribute information.

Hence, the present disclosure proposes an information processing device, an information processing method, and an information processing program that enable improvement in the accuracy of speech-related determination processing.

### Solution to Problem

To solve the above problems, an information processing device according to an embodiment includes: a first acquisition unit that acquires speech with which region information indicating a predetermined region and intention information indicating a caller intention are associated; and a generation unit that generates a speech determination model for determining the intention information of speech constituting a processing object on the basis of the speech acquired by the first acquisition unit and the region information associated with the speech.

Moreover, An information processing device according to an embodiment includes: a second acquisition unit that acquires speech constituting a processing object; a selection unit that selects, on the basis of region information associated with the speech acquired by the second acquisition unit, a speech determination model which corresponds to the region information from among a plurality of speech determination models; and a determination unit that uses the speech determination model selected by the selection unit to determine intention information indicating the caller intention of the speech acquired by the second acquisition unit.

### Advantageous Effects of Invention

According to an information processing device, an information processing method, and an information processing program according to the present disclosure, the accuracy of speech-related determination processing can be improved. Note that the advantageous effects disclosed here are not necessarily limited, rather, the advantageous effects may be any advantageous effects disclosed in the present disclosure.

### BRIEF DESCRIPTION OF DRAWINGS

FIG. 1 is a diagram providing an overview of information processing according to a first embodiment of the present disclosure.

FIG. 2 is a diagram to illustrate an overview of a method for constructing an algorithm according to the present disclosure.

FIG. 3 is a diagram to illustrate an overview of determination processing according to the present disclosure.

FIG. 4 is a diagram illustrating a configuration example of an information processing device according to the first embodiment of the present disclosure.

FIG. 5 is a diagram illustrating an example of a learning data storage unit according to the first embodiment of the present disclosure.

FIG. 6 is a diagram illustrating an example of a region-based model storage unit according to the first embodiment of the present disclosure.

FIG. 7 is a diagram illustrating an example of a common model storage unit according to the first embodiment of the present disclosure.

FIG. 8 is a diagram illustrating an example of an unwanted telephone number storage unit according to the first embodiment of the present disclosure.

FIG. 9 is a diagram illustrating an example of an action information storage unit according to the first embodiment of the present disclosure.

FIG. 10 is a diagram illustrating an example of registration processing according to the first embodiment of the present disclosure.

FIG. 11 is a flowchart illustrating the flow of generation processing according to the first embodiment of the present disclosure.

FIG. 12 is a flowchart illustrating the flow of registration processing according to the first embodiment of the present disclosure.

FIG. 13 is a flowchart (1) illustrating the flow of determination processing according to the first embodiment of the present disclosure.

FIG. 14 is a flowchart (2) illustrating the flow of determination processing according to the first embodiment of the present disclosure.

FIG. 15 is a diagram illustrating a configuration example of a speech processing system according to a second embodiment of the present disclosure.

FIG. 16 is a diagram illustrating a configuration example of a speech processing system according to a third embodiment of the present disclosure.

FIG. 17 is a hardware configuration diagram illustrating an example of a computer that realizes the functions of the information processing device.

### DESCRIPTION OF EMBODIMENTS

Embodiments of the present disclosure will be described in detail hereinbelow on the basis of the drawings. Note that duplicate descriptions are omitted from each of the embodiments hereinbelow by assigning the same reference signs to the same parts.

### 1. First Embodiment

[1-1. Overview of Information Processing According to First Embodiment]

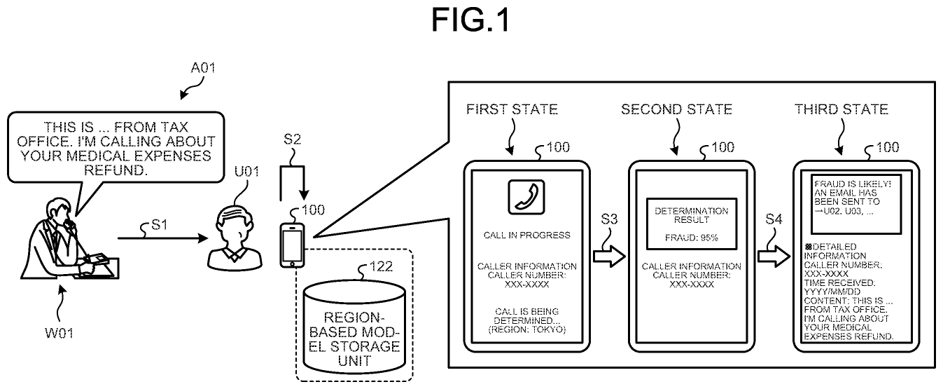

FIG. 1 is a diagram providing an overview of information processing according to a first embodiment of the present disclosure. The information processing according to a first embodiment of the present disclosure is executed by an information processing device 100 illustrated in FIG. 1.

The information processing device 100 is an example of the information processing device according to the present disclosure. The information processing device 100 is an information processing terminal which has a voice call function that uses a telephone line or a communications network or the like and is realized by a smartphone or the like, for example. The information processing device 100 is used by a user U01 which is an example of a user. Note that, when there is no need to distinguish the user U01 or the like, the user is generally referred to simply as “the user” hereinbelow. The first embodiment illustrates an example in which the information processing according to the present disclosure is executed by a dedicated application (hereinafter simply called “app”) which is installed on the information processing device 100.

The information processing device 100 according to the present disclosure determines attribute information of received speech (that is, speech uttered by a call recipient) when the call function is executed. Attribute information is a general term for characteristic information associated with speech. For example, attribute information is information indicating the intention of the person making the call (hereinafter referred to as “caller”). In the first embodiment, intention information about whether the speech of a call is related to fraud is described as attribute information by way of an example. That is, the information processing device 100 determines, on the basis of call speech, whether the caller of the call made to user U01 is planning to commit fraud upon user U01. The typical method when making such a determination is to carry out learning processing by using, as teaching data, speech when fraud has been committed in past incidents, and to generate a speech determination model for determining whether speech constituting a processing object involves fraud.

However, fraud (known as “special fraud”) in which a telephone call is used to deceive an unspecified call recipient, such as so-called “telephone fraud” or “bank payment fraud”, is known to be performed by cleverly changing the trick to suit the call recipient. For example, a person committing special fraud easily commits fraud by gaining the confidence of the call recipient by using a word (a place name or a store, or the like, which is local to the call recipient) or by speaking in a dialect tailored to the call recipient. Thus, special fraud sometimes has a different profile in each region where fraud is committed (the prefecture (administrative division) of Japan, or the like, for example), and hence the accuracy of fraud-related determination will likely not improve in the case of a speech determination model with which fraud-related speech is simply generated as learning data.

Therefore, the information processing device 100 according to the present disclosure acquires speech with which region information indicating a predetermined region and intention information indicating a caller intention are associated, collects the acquired speech, and generates a speech determination model for determining the intention information of speech constituting a processing object on the basis of the collected speech and the region information associated with the speech. Furthermore, upon acquiring the speech constituting the processing object, the information processing device 100 selects a speech determination model which corresponds to the region information from among a plurality of speech determination models on the basis of the region information associated with the speech. Further, the information processing device 100 uses the selected speech determination model to determine intention information indicating the caller intention of the speech. More specifically, the information processing device 100 determines whether the speech constituting the processing object is related to fraud.

Thus, the information processing device 100 generates a region-based speech determination model which uses speech with which region information is associated as learning data (hereinafter known as a “region-based model”), and makes a determination by using the region-based model. Accordingly, because the information processing device 100 enables a determination to be made in view of the “regionality” pertaining to special fraud, the determination accuracy can be improved. In addition, upon determining that the speech constituting the processing object is fraudulent, the information processing device 100 is capable of preventing the recipient of the speech from being involved in fraud with a high degree of reliability by performing a predetermined action such as issuing a notification to a pre-registered relevant party, or the like.

An overview of the information processing according to the present disclosure is provided hereinbelow alongside the process flow by using FIG. 1. Note that, in FIG. 1, the information processing device 100 has already generated a region-based model and that region-based models corresponding to each region are stored in the storage unit.

In the example illustrated in FIG. 1, a caller W01 is a person who is committing fraud upon user U01. For example, caller W01 places an inbound call to the information processing device 100 which is used by user U01 and utters speech A01, which includes content such as “This is . . . from the tax office. I'm calling about your medical expenses refund”. (step S1).

Upon receiving an inbound call, the information processing device 100 displays a screen to that effect. Furthermore, the information processing device 100 receives the inbound call and activates an app relating to speech determination (step S2). Note that, although a display is omitted in the example of FIG. 1, when caller information about caller W01 (for example, a caller number, which is the telephone number of caller W01) meets a predetermined condition, the information processing device 100 may display this fact on the screen. For example, when capable of referring to a database or the like of numbers corresponding to unwanted calls, the information processing device 100 checks the caller number against the database pertaining to unwanted calls, and when the caller number has been registered as an unwanted call, displays this fact on the screen. Alternatively, the information processing device 100 may automatically reject an incoming call when the caller number is an unwanted call.

In the example of FIG. 1, user U01 has received the inbound call from caller W01 and started the call. In this case, because the information processing device 100 specifies a receiving side region in order to select a region-based model which is used for speech determination. For example, the information processing device 100 acquires local device position information and specifies a region by specifying the prefecture (administrative division) of Japan, or the like, which corresponds to the position information. When a region has been specified, the information processing device 100 refers to a region-based model storage unit 122 in which region-based models are stored and selects the region-based model which corresponds to the specified region. In the example of FIG. 1, the information processing device 100 has selected the region-based model which corresponds to the region “Tokyo city” on the basis of the local device position information.

The information processing device 100 starts processing to determine speech on the basis of the selected region-based model. More specifically, the information processing device 100 inputs, to the region-based model, the speech A01 acquired via the call with caller W01. Thereupon, the information processing device 100 displays, on a screen, a display regarding a call being in progress, a caller number, and the fact that call content has been determined as per the first state illustrated in FIG. 1.

When the determination of speech A01 ends, the information processing device 100 shifts the screen display to the second state illustrated in FIG. 1 (step S3). The information processing device 100 then displays, on the screen, an output result for when speech A01 is inputted to the region-based model. Specifically, the information processing device 100 displays, as the output result, a numerical value indicating the probability that caller W01 intends to commit fraud (in other words, the probability that speech A01 is speech that has been uttered with a fraudulent intention), on the screen. More specifically, the information processing device 100 determines, from the output result of the region-based model, that the probability that caller W01 intends to commit fraud is “95%” and displays this determination result on the screen.

At such time, when the determination result exceeds a predetermined threshold value, the information processing device 100 executes a pre-registered action. When the action is executed, the information processing device 100 shifts the screen display to the third state indicated in FIG. 1 (step S4).

A predetermined action is, for example, processing or the like to notify a relevant party or a public body of the fact that user U01 is being subjected to fraud. More specifically, as an action, the information processing device 100 transmits an email to users U02 and U03, who are the wife (spouse) and children (relatives) of user U01, to the effect that user U01 has received a call which is likely fraudulent. Alternatively, the information processing device 100 may execute, as an action, a push notification or the like to a predetermined app which has been installed on the smartphones used by users U02 and U03. Thereupon, the information processing device 100 may append content, which is obtained by subjecting speech A01 to character recognition, to an email or a notification. Accordingly, upon receipt of the email or notification, users U02 and U03 are able to visually check the nature of the content of the call made to user U01 and investigate the likelihood of fraud. Note that the users toward whom an action is directed may be optionally set by user U01 and are not limited to being a spouse or relatives, and may be friends of user U01 or a work-related party (a boss or coworker, or someone responsible for customers, or the like), and so forth, for example. Furthermore, as an action, the information processing device 100 may make a call to a public body or the like (the police, for example) to automatically play back speech indicating the likelihood of fraud being committed.

Thus, upon acquiring the speech constituting the processing object, the information processing device 100 according to the first embodiment selects the region-based model which corresponds to the region information from among a plurality of speech determination models on the basis of the region information associated with the speech. Further, the information processing device 100 uses the selected region-based model to determine the intention information indicating the caller intention of the speech.

That is, the information processing device 100 determines the attribute information of the speech constituting the processing object by using a model with which not only caller intention information but also regionality, such as the region in which the speech is used, are learned. Accordingly, the information processing device 100 is capable of accurately determining attributes which are associated with speech having a region-based characteristic such as special fraud. Furthermore, according to the information processing device 100, because it is possible to construct a model that follows the latest trends regarding people committing fraud, for example, new fraudulent tricks can be dealt with rapidly.

Note that although a description is omitted from FIG. 1, the information processing device 100 may determine speech intention information by using not only a region-based model but also a speech determination model (hereinafter referred to as a “common model”) that does not rely on region information. For example, the information processing device 100 may perform a determination based on a plurality of models such as the region-based model and the common model, and may determine intention information for speech constituting a processing object on the basis of the results outputted by the plurality of models.

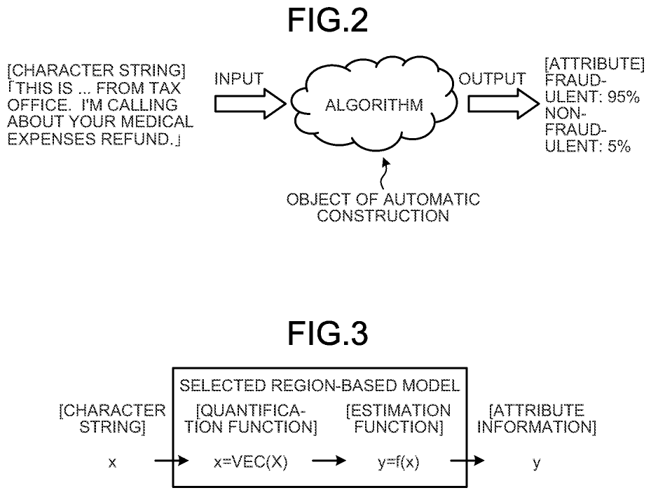

Note that the speech determination model according to the present disclosure may also be referred to as an algorithm for determining attribute information of speech constituting a processing object (in the first embodiment, information indicating an intention such as the caller having a fraudulent intention). That is, the information processing device 100 executes processing to construct this algorithm as processing to generate a speech determination model. The construction of an algorithm is executed by means of a machine learning method, for example. This feature will be described using FIG. 2. FIG. 2 is a diagram to illustrate an overview of a method for constructing an algorithm according to the present disclosure.

The information processing device 100 according to the present disclosure automatically constructs an analysis algorithm that enables attribute information to be estimated which represents characteristics of optional character strings (for example, character strings in which units of speech are recognized). According to this algorithm, as illustrated in FIG. 2, in the case of a character string such as “This is . . . from the tax office. I'm calling about your medical expenses refund”. being inputted, the likelihood of the attribute of this speech being fraudulent or non-fraudulent can be outputted. That is, the information processing device 100 is included in the construction of an analysis algorithm for obtaining the output illustrated in FIG. 2.

Note that, although FIG. 2 cites an example in which an input character string is speech, the technology of the present disclosure is applicable even when the input is a character string such as an email character string. Furthermore, attribute information is not limited to fraud, rather, various attribute information can be applied according to the construction of the algorithm (learning processing). For example, the technology of the present disclosure can be widely used in processing to handle spam email or in the construction of an algorithm for automatically classifying email content. That is, the technology of the present disclosure can be applied to the construction of various algorithms in which optional character strings are to be included.

The speech determination model algorithm according to the present disclosure is illustrated by means of the configuration as per FIG. 3, for example. FIG. 3 is a diagram to illustrate an overview of determination processing according to the present disclosure. As illustrated in FIG. 3, when the character string X is input, the speech determination model algorithm inputs the character string X to a quantification function VEC and subjects the characteristic amount of the character string to quantification (converts same to a numerical value). Furthermore, the speech determination model algorithm inputs the quantified value x to an estimation function f and calculates the attribute information y. The quantification function VEC and the estimation function f correspond to the speech determination model according to the present disclosure and are pre-generated prior to the determination processing of the speech constituting the processing object. That is, the method for generating the set of the quantification function VEC and the estimation function f which enable the attribute information y to be outputted corresponds to the algorithm construction method according to the present disclosure. The foregoing processing for generating the speech determination model and the configuration of the information processing device 100 that executes the speech determination processing using the speech determination model will be described in detail hereinbelow.

[1-2. Configuration of Information Processing Device According to First Embodiment]

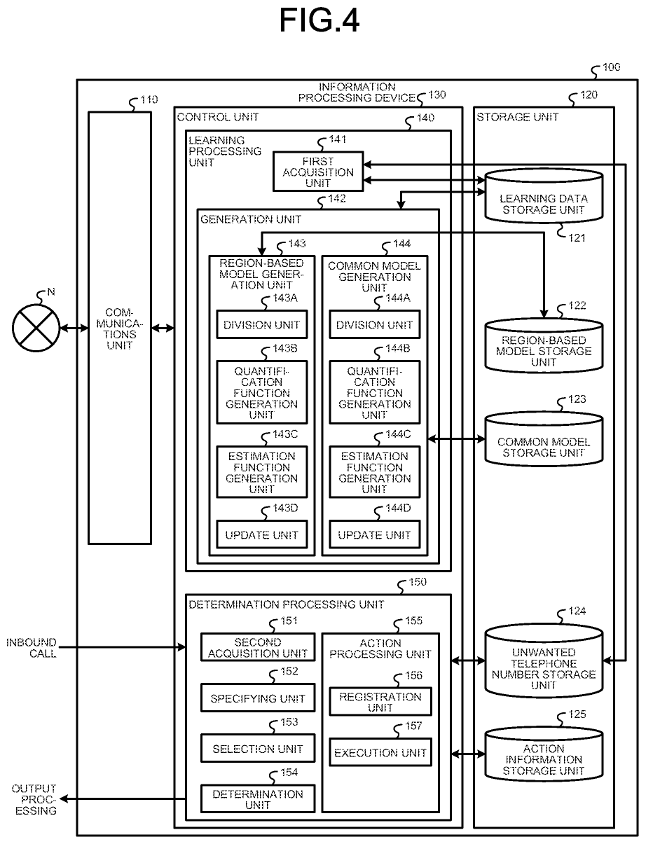

Next, the configuration of the information processing device 100, which is an example of an information processing device that executes speech processing according to the first embodiment, will be described. FIG. 4 is a diagram illustrating a configuration example of the information processing device 100 according to the first embodiment of the present disclosure.

As illustrated in FIG. 4, the information processing device 100 has a communications unit 110, a storage unit 120, and a control unit 130. Note that the information processing device 100 may have: an input unit (a keyboard or a mouse, or the like, for example) for receiving various operations from an administrator or the like using the information processing device 100; and a display unit (a liquid crystal display or the like, for example) for displaying various information.

The communications unit 110 is realized by a network interface card (NIC) or the like, for example. The communications unit 110 is connected to a network N by a cable or wirelessly and exchanges information with an external server or the like via the network N.

The storage unit 120 is realized, for example, by a semiconductor memory element such as a random-access memory (RAM) or a flash memory, or by a storage device such as a hard disk or an optical disk. The storage unit 120 has a learning data storage unit 121, a region-based model storage unit 122, a common model storage unit 123, an unwanted telephone number storage unit 124, and an action information storage unit 125. The storage units will each be described in order hereinbelow.

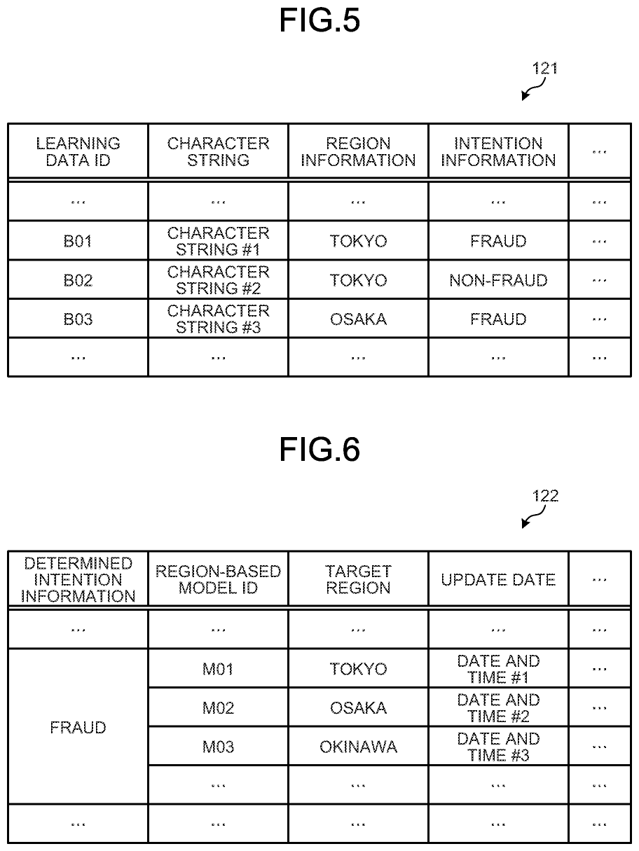

The learning data storage unit 121 stores learning data groups which are used in processing to generate speech determination models. FIG. 5 illustrates an example of the learning data storage unit 121 according to the first embodiment. FIG. 5 is a diagram illustrating an example of the learning data storage unit 121 according to the first embodiment of the present disclosure. In the example illustrated in FIG. 5, the learning data storage unit 121 has the items “learning data ID”, “character string”, “region information”, and “intention information”.

“Learning data ID” indicates identification information identifying learning data. “Character string” indicates the character string which is included in the learning data. A character string is text data or the like which is obtained by subjecting speech of past calls to speech recognition and representing same as a character string, for example. Note that, although a character string item appears conceptually as “character string #1” in the example illustrated in FIG. 5, in reality, the character string item stores specific characters representing a unit of speech as a character string.

“Region information” is information related to a region which is associated with learning data. In the first embodiment, region information is determined on the basis of position information or address information, or the like, of the call recipient. That is, region information is determined by the position or place of residence, or the like, of a user receiving a call with a certain intention (in the first embodiment, whether the intention of the call is fraud). Note that, although the region information is denoted by the name of a prefecture (an administrative division) of Japan in the example illustrated in FIG. 5, the region information may also be a name denoting a certain region (the Kanto region or the Kansai region of Japan, and so forth) or may be a name denoting an optional locality (a government ordinance city of Japan or the like).

“Intention information” indicates information about the intention of the caller of the character string. In the example of FIG. 5, the intention information is information indicating whether the intention of the caller is fraud. For example, the learning data illustrated in FIG. 5 is constructed by a public body (the police or the like) that is capable of collecting fraudulent telephone calls or by a private organization that collects fraud conversation samples.

That is, in the example illustrated in FIG. 5, it can be seen that learning data for which the learning data ID is identified as “B01” has the character string “character string #1”, the region information “Tokyo”, and the intention information “fraud”.

Next, the region-based model storage unit 122 will be described. The region-based model storage unit 122 stores a region-based model which is generated by a generation unit 142. FIG. 6 illustrates an example of the region-based model storage unit 122 according to the first embodiment. FIG. 6 is a diagram illustrating an example of the region-based model storage unit 122 according to the first embodiment of the present disclosure. In the example illustrated in FIG. 6, the region-based model storage unit 122 has the items “determined intention information”, “region-based model ID”, “target region”, and “update date”.

The “determined intention information” indicates the type of intention information to be included in the determination using the region-based model. The “region-based model ID” indicates identification information identifying the region-based model. The “target region” indicates a region to be included in the determination using the region-based model. The “update date” indicates the date and time when the region-based model is updated. Note that, although the update date item appears conceptually as “date and time #1” in the example illustrated in FIG. 6, in reality, the update date item stores a specific date and time.

That is, in the example illustrated in FIG. 6, it can be seen that one region-based model for which the determined intention information is “fraud” and that a region-based model, which is identified by the region-based model ID “M01”, has a target region “Tokyo” and an update date of “date and time #1”.

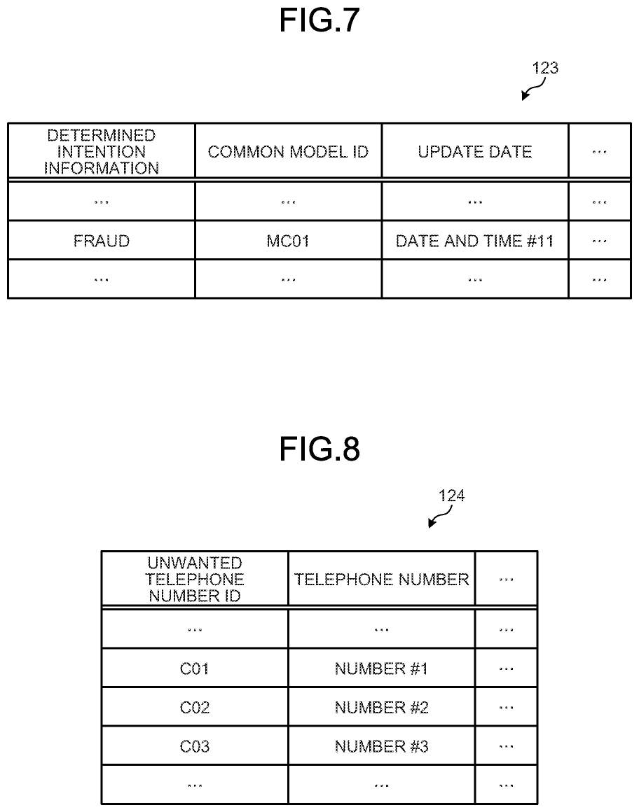

Next, the common model storage unit 123 will be described. The common model storage unit 123 stores a common model which is generated by the generation unit 142. FIG. 7 illustrates an example of the common model storage unit 123 according to the first embodiment. FIG. 7 is a diagram illustrating an example of the common model storage unit 123 according to the first embodiment of the present disclosure. In the example illustrated in FIG. 7, the common model storage unit 123 has the items “determined intention information”, “common model ID”, and “update date”.

The “determined intention information” indicates the type of intention information to be included in the determination using the common model. The “common model ID” indicates identification information identifying a common model. For the common model, a different model is generated for each determined intention information, for example, and different identification information is assigned thereto. The “update date” indicates the date and time when the common model is updated.

That is, in the example illustrated in FIG. 7, it can be seen that the common model with the determined intention information “fraud” is a model which is identified as having a common model ID “MC01” and that the update date thereof is “date and time #11”.

Next, the unwanted telephone number storage unit 124 will be described. The unwanted telephone number storage unit 124 stores caller information estimated to be an unwanted call (for example, the telephone number corresponding to the person making the unwanted call). FIG. 8 illustrates an example of the unwanted telephone number storage unit 124 according to the first embodiment. FIG. 8 is a diagram illustrating an example of the unwanted telephone number storage unit 124 according to the first embodiment of the present disclosure. In the example illustrated in FIG. 8, the unwanted telephone number storage unit 124 has the items “unwanted telephone number ID” and “telephone number”.

“Unwanted telephone number ID” indicates identification information identifying a telephone number estimated to be an unwanted call (in other words, the caller). “Telephone number” indicates the telephone number estimated to be an unwanted call. Same is a numerical value indicating a specific telephone number. Note that, although the telephone number item appears conceptually as “number #1” in the example illustrated in FIG. 8, in reality, the telephone number item stores a specific numerical value indicating a telephone number. Note that the information processing device 100 may be provided with the unwanted call information which is stored in the unwanted telephone number storage unit 124, by a public body that owns an unwanted call-related database, for example.

That is, in the example illustrated in FIG. 8, it can be seen that a caller of an unwanted call for which the unwanted telephone number ID “C01” is indicated has a corresponding telephone number “number #1”.

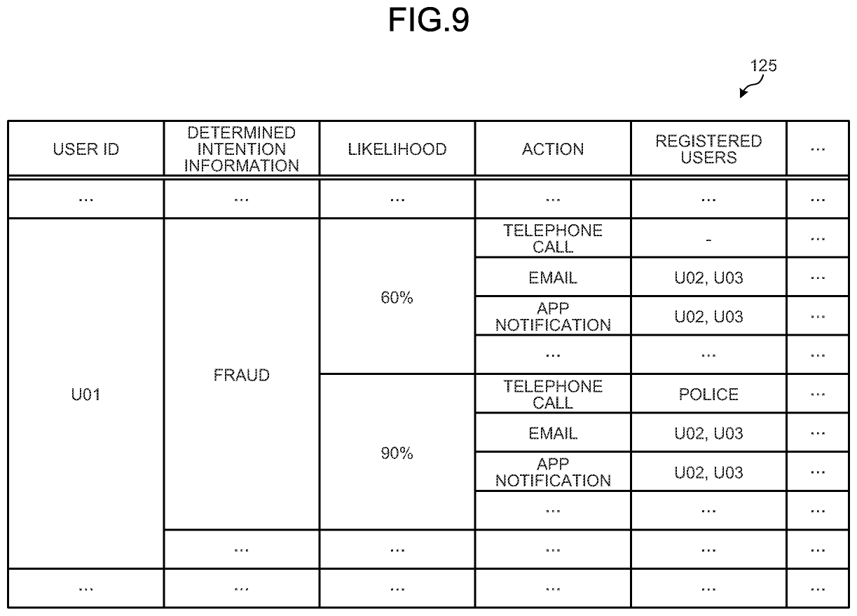

Next, the action information storage unit 125 will be described. When the user of the information processing device 100 receives speech having predetermined intention information, the action information storage unit 125 stores the content of an action that is automatically executed. FIG. 9 illustrates an example of the action information storage unit 125 according to the first embodiment. FIG. 9 is a diagram illustrating an example of the action information storage unit 125 according to the first embodiment of the present disclosure. In the example illustrated in FIG. 9, the action information storage unit 125 has the items “user ID”, “determined intention information”, “likelihood”, “action”, and “registered users”.

“User ID” indicates identification information identifying users using the information processing device 100. “Determined intention information” indicates intention information which is associated with an action. That is, upon observing the intention information indicated in the determined intention information, the information processing device 100 executes an action which is registered in association with the determined intention information.

“Likelihood” indicates the likelihood (probability) which is estimated for the caller intention. As illustrated in FIG. 9, the user is able to register a likelihood-specific action such as executing a more reliable action when the likelihood of fraud is higher. “Action” indicates the content of the processing that is automatically executed by the information processing device 100 determining the speech. “Registered users” indicates identification information identifying users toward whom the action is directed. Note that registered users may be indicated, not by specific user names or the like, but rather by information such as mail addresses and telephone numbers and the like, and contact information associated with the users.

That is, in the example illustrated in FIG. 9, it can be seen that, for user U01, who is identified by the user UD “U01”, registration is performed so that predetermined actions are carried out when speech is acquired that has the determined intention information “fraud” and that is determined as fraudulent with a likelihood exceeding “60%”. More specifically, it can be seen that, when the likelihood of fraud exceeds “60%”, an “email” is transmitted to registered users “U02” and “U03”, and an “app notification” is issued to registered users “U02” and “U03”, as actions. It can also be seen that, when the likelihood of fraud exceeds “90%”, a “telephone call” is made to the registered user “police”, an “email” is transmitted to registered users “U02” and “U03”, and an “app notification” is issued to registered users “U02” and “U03”, as actions.

Returning to FIG. 4, the description will now be resumed. The control unit 130 is realized as a result of a program stored in the information processing device 100 (the information processing program according to the present disclosure, for example) being executed by a central processing unit (CPU) or a micro processing unit (MPU), or the like, for example, by using a random-access memory (RAM) or the like as a working region. In addition, the control unit 130 may be a controller and may be realized, for example, by an integrated circuit such as an application specific integrated circuit (ASIC) or a field programmable gate array (FPGA), or the like.

As illustrated in FIG. 4, the control unit 130 has a learning processing unit 140 and a determination processing unit 150 and realizes or executes the information processing functions and actions described hereinbelow. Note that the internal configuration of the control unit 130 is not limited to the configuration illustrated in FIG. 4, rather, another configuration is possible as long as the configuration performs the information processing described subsequently.

The learning processing unit 140 learns an algorithm for determining the attribute information of speech constituting a processing object on the basis of learning data. More specifically, the learning processing unit 140 generates a speech determination model for determining intention information for the speech constituting the processing object. The learning processing unit 140 has a first acquisition unit 141 and a generation unit 142.

The first acquisition unit 141 acquires speech with which region information indicating a predetermined region and intention information indicating a caller intention are associated. Further, the first acquisition unit 141 stores the acquired speech in the learning data storage unit 121.

More specifically, the first acquisition unit 141 acquires, as intention information, speech with which information indicating whether a caller is trying to commit fraud is associated. For example, the first acquisition unit 141 acquires, from a public body or the like, speech relating to incidents when fraud has actually been committed. In this case, the first acquisition unit 141 labels the speech as “fraudulent” as intention information and stores same in the learning data storage unit 121 as a positive instance of learning data. Further, the first acquisition unit 141 acquires everyday call speech which is not fraudulent. In this case, the first acquisition unit 141 labels the speech as “non-fraudulent” as intention information and stores same in the learning data storage unit 121 as a negative instance of learning data.

Note that the first acquisition unit 141 may acquire speech with which region information has been associated beforehand and may, on the basis of position information of a receiver device that receives the speech, determine region information associated with the speech. For example, even in a case where region information has not been associated with the acquired speech, when it is possible to acquire position information for the device (that is, the telephone) with which the speech was acquired in a fraud incident, the first acquisition unit 141 determines region information on the basis of the position information. More specifically, the first acquisition unit 141 refers to the map data or the like which associates the position information with region information such as the prefecture (administrative division) of Japan, and determines the region information on the basis of the position information. Note that the first acquisition unit 141 does not necessarily need to determine region information for speech which is acquired as learning data. For example, the first acquisition unit 141 is capable of using speech with which region information is not associated as learning data for when a common model is generated.

Furthermore, the first acquisition unit 141 may acquire, in addition to learning data, information relating to unwanted calls from which a database has been created by a public body or the like. The first acquisition unit 141 stores information relating to the acquired unwanted calls in the unwanted telephone number storage unit 124. For example, when a caller number has been registered as an unwanted telephone number, the determination processing unit 150, described subsequently, may determine that the caller is someone with a bad intention without performing model-based determination processing, and may perform processing such as call rejection. Accordingly, the determination processing unit 150 is capable of ensuring the safety of a call recipient without the burden of processing such as model determination. Note that an unwanted telephone number may be optionally set by the user of the information processing device 100, for example, without being acquired from a public body or the like. The user is thus able to optionally register, by themselves, only the number of the caller to be rejected as an unwanted telephone number.

The generation unit 142 has a region-based model generation unit 143 and a common model generation unit 144, and generates a speech determination model on the basis of speech acquired by the first acquisition unit 141. For example, the generation unit 142 generates a speech determination model for determining intention information for speech constituting a processing object on the basis of the speech acquired by the first acquisition unit 141 and region information which is associated with the speech. More specifically, the generation unit 142 generates a region-based model that performs a determination of intention information for each predetermined region such as each prefecture (administrative division) of Japan and generates a common model for determining intention information as a common reference that is independent of region information.

For example, the generation unit 142 generates, as intention information, a speech determination model for determining whether optional speech indicates that a caller intends to commit fraud. That is, when speech constituting a processing object is inputted, the generation unit 142 generates a model for determining whether the speech is fraud-related speech by using speech relating to fraud incidents as learning data.

Here, specific model generation processing will be described by citing the region-based model generation unit 143 and the common model generation unit 144 as examples. Note that the region-based model generation unit 143 performs learning by using speech with which specific region information is associated, and the common model generation unit 144 performs learning which is independent of region information. However, the processing method itself for generating a model is the same in either case.

As illustrated in FIG. 4, the region-based model generation unit 143 has a division unit 143A, a quantification function generation unit 143B, an estimation function generation unit 143C, and an update unit 143D.

Through division of acquired speech, the division unit 143A converts the speech into a form for executing the processing which is described subsequently. For example, the division unit 143A subjects the speech to character recognition and divides the recognized character strings into morphemes. Note that the division unit 143A may subject the recognized character strings to n-gram analysis to divide the character strings. The division unit 143A is not limited to the foregoing method and may use various existing techniques to divide the character strings.

The quantification function generation unit 143B quantifies the speech divided by the division unit 143A. For example, the quantification function generation unit 143B performs, for the morphemes included in a conversation (one speech among the learning data), vectorization based on the term frequency (TF) in each conversation and the inverse document frequency (IDF) across all conversations (learning data), and performs quantification of each conversation by using dimensional compression. Note that, when a region-based model is generated, all conversations means all the conversations with common region information (all conversations with which “Tokyo” region information is associated, for example). Note that, for the quantification, the quantification function generation unit 143B may quantify all the conversations by using an existing word-embedding technology (for example, word2vec, a doc2vec, sparse composite document vectors (SCDV), or the like). Note that the quantification function generation unit 143B may quantify the speech by using a variety of existing techniques in addition to the foregoing cited methods.

The estimation function generation unit 143C generates, for each region, an estimation function for estimating the degree of attribute information from a quantified value, on the basis of the relationship between the speech quantified by the quantification by the quantification function generation unit 143B, and the attribute information of the speech. More specifically, the estimation function generation unit 143C executes supervised machine learning by using the value quantified by the quantification function generation unit 143B as an explanatory variable and by using the attribute information as an objective variable. Further, the estimation function generation unit 143C takes the estimation function obtained as a result of machine learning as a region-based model and stores same in the region-based model storage unit 122. Note that various methods may be used as the learning method executed by the estimation function generation unit 143C, irrespective of whether learning is supervised or not supervised. For example, the estimation function generation unit 143C may generate a region-based model by using various learning algorithms such as a neural network, a support vector machine, clustering, or reinforcement learning.

The update unit 143D updates the region-based model which is generated by the estimation function generation unit 143C. For example, when new learning data is acquired, the update unit 143D may update the region-based model which is generated. The update unit 143D may also update the region-based model when the determination processing unit 150 (described subsequently) receives feedback for a determined result. For example, in a case where the determination processing unit 150 receives feedback that speech which has been determined to be “fraudulent” is actually “non-fraudulent”, the update unit 143D may update the region-based model on the basis of data (correct-answer data) in which the speech is corrected as “fraudulent”.

Note that, although the common model generation unit 144 has a division unit 144A, a quantification function generation unit 144B, an estimation function generation unit 144C, and an update unit 144D, the processing executed by each processing unit corresponds to the processing executed by each of the processing units with the same name which are included in the region-based model generation unit 143. However, the common model generation unit 144 differs from the region-based model generation unit 143 in that learning is performed using the learning data of all the regions determined in past incidents to be “fraudulent” and “non-fraudulent”. Furthermore, the common model generation unit 144 stores common models which have been generated in the common model storage unit 123.

The determination processing unit 150 will be described next. The determination processing unit 150 uses the model generated by the learning processing unit 140 to make a determination for the speech constituting the processing object, and executes various actions according to the determination result. As illustrated in FIG. 4, the determination processing unit 150 has a second acquisition unit 151, a specifying unit 152, a selection unit 153, a determination unit 154, and an action processing unit 155. Further, the action processing unit 155 has a registration unit 156 and an execution unit 157.

The second acquisition unit 151 acquires the speech constituting the processing object. More specifically, the second acquisition unit 151 acquires speech uttered by a caller by receiving an inbound call from the caller via a call function of the information processing device 100.

Note that the second acquisition unit 151 may check the caller information of the speech against a list indicating whether a caller is suitable as a speech caller, and may acquire, as speech constituting the processing object, only speech uttered by a caller deemed suitable as a speech caller. More specifically, the second acquisition unit 151 may check the caller number against a database which is stored in the unwanted telephone number storage unit 124, and may acquire only the speech of calls which do not correspond to unwanted telephone numbers.

The specifying unit 152 specifies region information with which the speech acquired by the second acquisition unit 151 is associated.

For example, the specifying unit 152 specifies region information which is associated with the speech acquired by the second acquisition unit 151, on the basis of the position information of the receiver device that receives the speech. Note that, when the information processing device 100 has a call function, the speech receiver device signifies the information processing device 100 which receives the inbound call from the caller.

For example, the specifying unit 152 acquires the position information by using a global positioning system (GPS) function or the like of the information processing device 100. Note that position information may be information or the like which is acquired from communication with a specified access point, for example, in addition to numerical values for longitude and latitude, or the like. That is, the position information may be any information as long as same is information enabling the determination of a predetermined range which can be applied to a region-based model (for example, the predetermined boundaries of a prefecture (administrative division) or municipality of Japan, or the like).

The selection unit 153 selects a speech determination model which corresponds to the region information from among a plurality of speech determination models, on the basis of the region information associated with the speech acquired by the second acquisition unit 151. More specifically, the selection unit 153 selects a speech determination model which has been learned on the basis of speech with which intention information indicating whether the caller is attempting fraud is associated.

Note that the selection unit 153 may select a first speech determination model on the basis of the region information and select a second speech determination model which differs from the first speech determination model. More specifically, the selection unit 153 selects a region-based model which is the first speech determination model on the basis of the region information of the speech constituting a processing object. In addition, the selection unit 153 selects a common model which is the second speech determination model independently of the region information of the speech constituting the processing object. In this case, the determination unit 154, described subsequently, determines whether the speech constituting the processing object is fraud-related speech on the basis of a score (probability) for which the likelihood of fraud is higher among the plurality of speech determination models. Thus, the selection unit 153 is capable of improving the accuracy of the determination processing of speech constituting a processing object by selecting a plurality of models such as a region-based model and a common model.

The determination unit 154 uses the speech determination model selected by the selection unit 153 to determine intention information indicating the caller intention of the speech acquired by the second acquisition unit 151. For example, the determination unit 154 uses the speech determination model selected by the selection unit 153 to determine whether the speech acquired by the second acquisition unit 151 represents a fraudulent intention.

More specifically, the determination unit 154 subjects the acquired speech to character recognition and divides the recognized character strings into morphemes. Further, the determination unit 154 inputs the speech divided into morphemes to the speech determination model selected by the selection unit 153. Using the speech determination model, the speech which is first inputted is quantified by a quantification function. Note that the quantification function is a function which is generated by the quantification function generation unit 143B and the quantification function generation unit 144B, for example, and is a function corresponding to a model to which the speech constituting the processing object is inputted. Furthermore, by inputting the quantified value to an estimation function, the speech determination model outputs a score indicating an attribute corresponding to speech. The determination unit 154 determines whether the processing-object speech has the attribute on the basis of the outputted score.

For example, when it is determined, as the speech attribute, whether the speech is fraud-related speech, the determination unit 154 uses the speech determination model to output a score indicating that the speech is fraud-related speech. Further, the determination unit 154 determines that the speech is fraudulent when the score exceeds a predetermined threshold value. Note that the determination unit 154 need not make a “1” or “0” determination to indicate whether the speech is fraudulent and may determine the probability that the speech is fraudulent according to the outputted score. For example, the determination unit 154 is capable of indicating the probability of the speech being fraudulent according to the outputted score by performing normalization so that the output value of the speech determination model matches the probability. In this case, if the score is “60”, for example, the determination unit 154 determines that the probability of the speech being fraudulent is “60%”.

Note that the determination unit 154 may use a region-based model and a common model, respectively, to determine intention information indicating the caller intention of the speech acquired by the second acquisition unit 151. In this case, the determination unit 154 may use the region-based model and the common model, respectively, to calculate the respective scores indicating the likelihood of the speech being fraud-related speech, and may determine, on the basis of the score indicating a higher likelihood of the speech being fraud-related speech, whether the speech is fraud-related speech. Thus, by using a plurality of models with different determination references to perform determination processing, the determination unit 154 is capable of improving the likelihood of avoiding an “incident in which a case of real fraud is not determined as fraud”.

The action processing unit 155 controls the registration and execution of actions which are executed according to results determined by the determination unit 154.

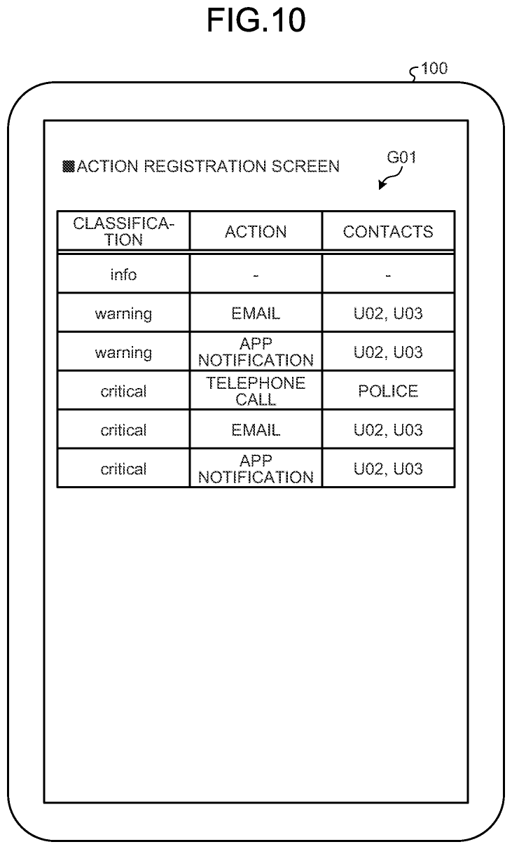

The registration unit 156 registers actions according to settings or the like by the user. Here, processing for registering actions will be described using FIG. 10. FIG. 10 is a diagram illustrating an example of registration processing according to the first embodiment of the present disclosure. FIG. 10 illustrates an example of a screen display for when a user registers an action.

Table G01 in FIG. 10 includes the items “classification”, “action”, and “contacts”. “Classification” corresponds to the item “likelihood” illustrated in FIG. 9, for example. For example, “info” illustrated in FIG. 10 indicates the setting for the action to be performed upon receiving a call with a low likelihood of fraud (the model output score is equal to or below a predetermined threshold value). Furthermore, “warning” illustrated in FIG. 10 indicates the setting for the action to be performed upon receiving a call with a slightly higher likelihood of fraud (the model output score exceeds a first threshold value (of 60% or similar, for example)). Further, “critical” illustrated in FIG. 10 indicates the setting for the action to be performed upon receiving a call with a very high likelihood of fraud (the model output score exceeds a second threshold value (of 90% or similar, for example).

In addition, “action” in table G01 of FIG. 10 corresponds to the item “action” illustrated in FIG. 9, for example, and indicates specific action content. In addition, “contacts” in table G01 of FIG. 10 corresponds to the item “registered users” illustrated in FIG. 9, for example, and indicates the name, or the like, of a user or an organization toward which an action is directed. The user pre-registers an action via a user interface like the action registration screen illustrated in FIG. 10. The registration unit 156 registers an action according to the content received from the user. More specifically, the registration unit 156 stores the content of the received action in the action information storage unit 125.

The execution unit 157 executes notification processing for a registrant who is pre-registered on the basis of the intention information determined by the determination unit 154. More specifically, the execution unit 157 issues, to the registrant, a predetermined notification indicating that the speech is fraud-related speech when it is determined by the determination unit 154 that the likelihood of the speech being fraud-related speech exceeds a predetermined threshold value.

More specifically, the execution unit 157 refers to the action information storage unit 125 to specify the result (likelihood of fraud) determined by the determination unit 154 and the action registered by the registration unit 156. Further, the execution unit 157 executes, with respect to a registrant user or the like, a pre-registered action such as an email, an app notification or a telephone call, or the like. In the example illustrated in FIG. 9, upon determining that user U01 has received a call for which the likelihood of fraud exceeds 60%, the execution unit 157 executes the actions of an email and an app notification to users U02 and U03.

In addition, the execution unit 157 may issue, to a registrant, notification of a character string which is the result of subjecting speech to speech recognition. More specifically, the execution unit 157 subjects the content of a conversation by a caller to character recognition and transmits the recognized character string by attaching same to an email or an app notification, or the like. Thus, the user receiving the notification is able to ascertain, from text, whether a call recipient has received this kind of call, and is thus able to more accurately determine whether fraud has actually been committed upon the call recipient. Furthermore, even for a call which is determined by the model to be fraudulent, the user receiving the notification is able to determine, through human verification, that the call is not actually fraudulent, and therefore prevent determination errors and the accompanying confusion, and so forth.

[1-3. Procedure for Information Processing According to First Embodiment]

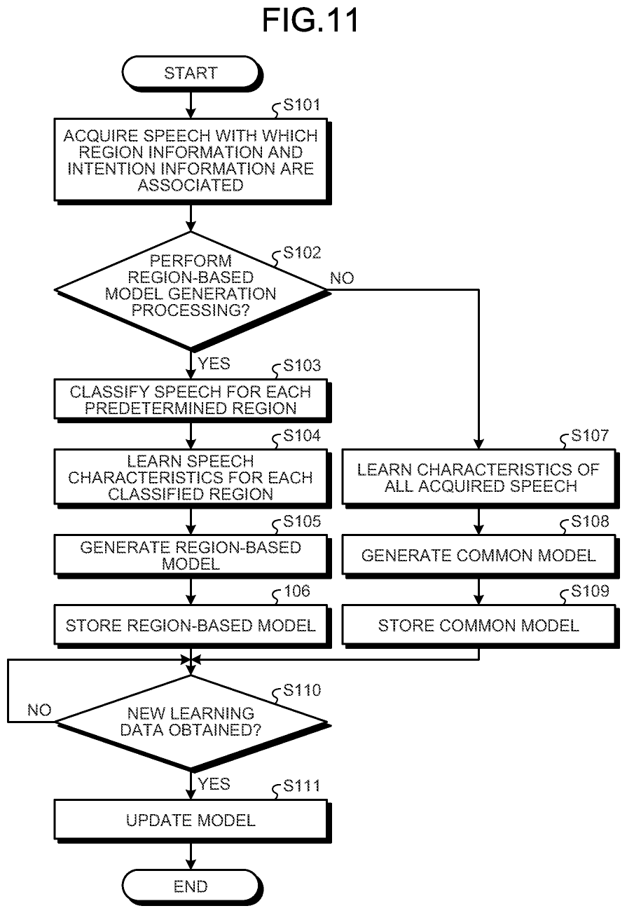

The procedure for the information processing according to the first embodiment will be described next using FIGS. 11 to 14. First, the procedure for the generation processing according to the first embodiment will be described using FIG. 11. FIG. 11 is a flowchart illustrating the flow of generation processing according to the first embodiment of the present disclosure.

As illustrated in FIG. 11, the information processing device 100 acquires speech with which region information and intention information are associated (step S101). Thereafter, the information processing device 100 selects whether to execute region-based model generation processing (step S102). When region-based model generation is performed (step S102; Yes), the information processing device 100 classifies the speech by predetermined region (step S103).

Further, the information processing device 100 learns speech characteristics for each classified region (step S104). That is, the information processing device 100 generates a region-based model (step S105). Further, the information processing device 100 stores the generated region-based model in the region-based model storage unit 122 (step S106).

Meanwhile, when performing common model generation instead of generating a region-based model (step S102; No), the information processing device 100 learns the characteristics of all the acquired speech (step S107). That is, the information processing device 100 performs learning processing irrespective of the acquired speech region information. The information processing device 100 then generates a common model (step S108). Further, the information processing device 100 stores the generated common model in the common model storage unit 123 (step S109).

Thereafter, the information processing device 100 determines whether new learning data has been obtained (step S110). Note that new learning data may be newly acquired speech or may be feedback from a user who has actually received a call. When new learning data has not been obtained (step S110; No), the information processing device 100 stands by until new learning data is obtained. If, on the other hand, new learning data has been obtained (step S110; Yes), the information processing device 100 updates the stored model (step S111). Note that the information processing device 100 may be configured to check the determination accuracy of the current model and update the model when it is determined that it should be updated. In addition, a model update may be performed at predetermined intervals (every week or every month, or the like, for example) which are preset rather than at the moment the new learning data is obtained.

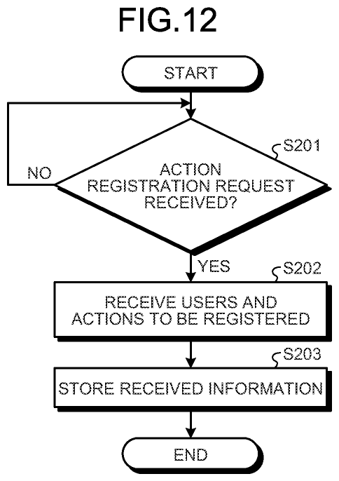

Next, the procedure for the registration processing according to the first embodiment will be described using FIG. 12. FIG. 12 is a flowchart illustrating the flow of registration processing according to the first embodiment of the present disclosure. Note that the information processing device 100 may receive registration processing with optional user timing, or may encourage the user to perform registration by displaying on the screen, with predetermined timing, a request to perform registration.

As illustrated in FIG. 12, the information processing device 100 determines whether an action registration request has been received from the user (step S201). When an action registration request has not been received (step S201; No), the information processing device 100 stands by until an action registration request is received.

If, on the other hand, an action registration request is received (step S201; Yes), the information processing device 100 receives the users (the users toward whom the actions are directed) and the content of the actions to be registered (step S202). Further, the information processing device 100 stores information related to the received actions in the action information storage unit 125 (step S203).

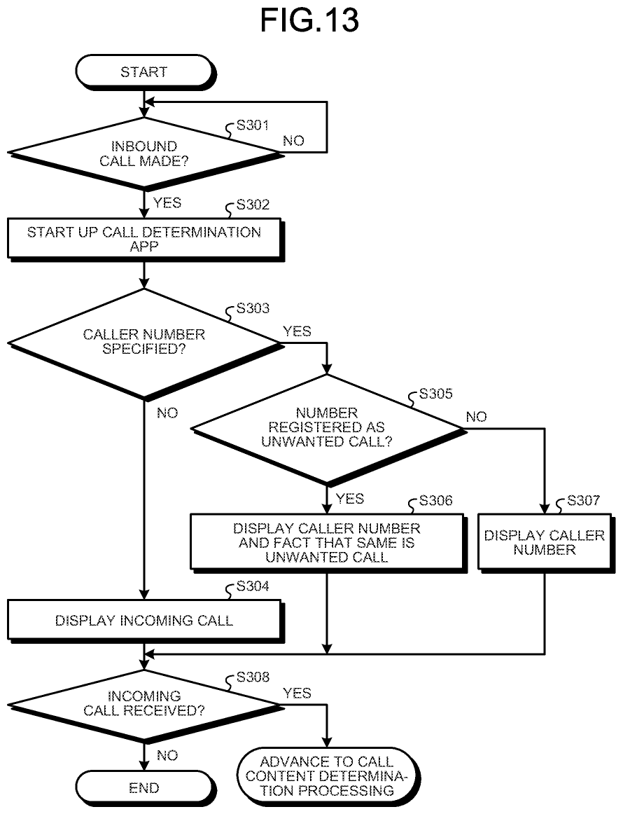

Next, the procedure for the determination processing according to the first embodiment will be described using FIG. 13. FIG. 13 is a flowchart (1) illustrating the flow of determination processing according to the first embodiment of the present disclosure.

First, the information processing device 100 determines whether an inbound call has been made to the information processing device 100 (step S301). When there is no inbound call (step S301; No), the information processing device 100 stands by until there is an inbound call.

If, on the other hand, there is an inbound call (step S301; Yes), the information processing device 100 starts up a call determination app (step S302). Thereafter, the information processing device 100 determines whether a caller number has been specified (step S303). When a caller number has not been specified (step S303; No), the information processing device 100 skips the processing of step S305 and subsequent steps, and displays only the fact that there is an incoming call without displaying a caller number (step S304). Note that a case where a caller number has not been specified refers to a case such as where the caller receives an inbound call with a non-notification setting or the like in place and where a caller number has not been acquired on the information processing device 100 side, for example.

If, on the other hand, a caller number has been specified (step S303; Yes), the information processing device 100 refers to the unwanted telephone number storage unit 124 and determines whether the caller number is a number which has been registered as an unwanted call (step S305).

If a caller number has been registered as an unwanted call (step S305; Yes), the information processing device 100 displays the incoming call and displays, on the screen, that the caller number is an unwanted call (step S306). Note that the information processing device 100 may, according to a user setting, perform processing to reject the arrival of an inbound call that is determined as being an unwanted call.

If, on the other hand, a caller number has not been registered as an unwanted call (step S305; No), the information processing device 100 displays the fact that there is an incoming call on the screen along with the caller number (step S307).

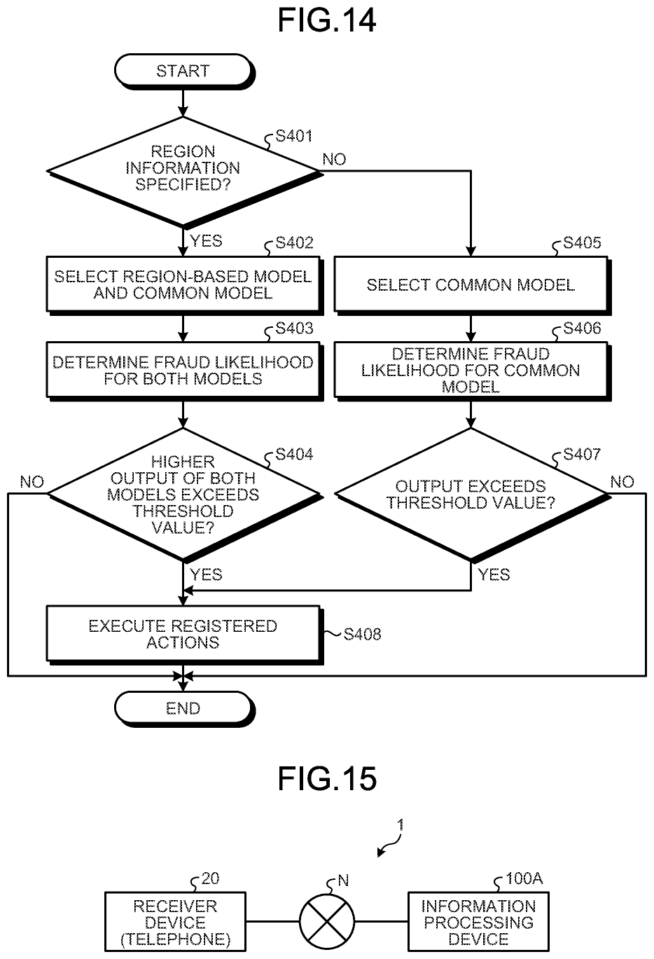

Thereafter, the information processing device 100 determines whether the user has accepted the arrival of the inbound call (step S308). When the user does not accept the arrival of an inbound call (step S308; No), that is, when the user performs an operation to reject the call, or similar, the information processing device 100 ends the determination processing. If, on the other hand, the user accepts the arrival of the inbound call (step S308; Yes), that is, when a call between the caller and the user has started, the information processing device 100 starts the call content determination processing. The following processing is described using FIG. 14.

FIG. 14 is a flowchart (2) illustrating the flow of determination processing according to the first embodiment of the present disclosure. As illustrated in FIG. 14, the information processing device 100 determines whether region information relating to the call has been specified (step S401). Note that, when region information has been specified, this indicates that position information on the location of the local device of the information processing device 100 has been detected by a GPS function or other such function of the local device, or the like, and that region information has been specified. Furthermore, when region information has not been specified, this indicates that position information has not been detected by a GPS or other such function and that region information has not been specified.

When region information has been specified (step S401; Yes), the information processing device 100 selects, as a model for determining call speech, a region-based model corresponding to the specified region and a common model (step S402). Further, the information processing device 100 inputs the speech acquired from the caller to both models and determines the likelihood of fraud for each model (step S403).

Furthermore, the information processing device 100 determines whether the higher output among the values outputted from the two models exceeds a threshold value (step S404). When the higher output among the outputs of the two models exceeds the threshold value (step S404; Yes), the information processing device 100 executes the registered action according to the threshold value (step S408). If, on the other hand, neither of the outputs from the two models exceeds the threshold value (step S404; No), the information processing device 100 ends the determination processing without executing the action.

Note that, when region information is not specified in S401 (step S401; No), the information processing device 100 cannot select the region-based model and therefore selects only a common model (step S405). Further, the information processing device 100 determines the likelihood of fraud using the common model by inputting the speech acquired from the caller to the common model (step S406).

In addition, the information processing device 100 determines whether the output of the common model exceeds a threshold value (step S407). When the output exceeds the threshold value (step S407; Yes), the information processing device 100 executes a registered action according to the threshold value (step S408). If, on the other hand, the output does not exceed the threshold value (step S407; No), the information processing device 100 ends the determination processing without executing the action.

[1-4. Modification Example According to First Embodiment]

The information processing described in the foregoing first embodiment may be accompanied by various modifications. For example, the information processing device 100 may specify a region by using a different reference rather than a prefecture (administrative division) of Japan or the like.

For example, it is assumed that the tricks relating to special fraud or the like as indicated in the first embodiment differ between so-called urban areas and non-urban areas. Hence, the information processing device 100 may classify regions as “urban areas” or “non-urban areas” rather than classifying regions as contiguous regions such as prefectures (administrative divisions) of Japan. The information processing device 100 may also individually generate a region-based model corresponding to “urban areas” and a region-based model corresponding to “non-urban areas”. Accordingly, the information processing device 100 is capable of generating a model for dealing with fraud where tricks and so forth tailored to the living environment are rampant, and hence enables the accuracy of fraud determination to be improved.

Furthermore, the information processing device 100 may also specify a region irrespective of the position information of the local device or other such receiver device. For example, the information processing device 100 may receive an input regarding an address or the like from the user when the app is initially configured and may specify region information on the basis of the inputted information.

In addition, the specifying unit 152 pertaining to the information processing device 100 may specify region information, with which the speech acquired by the second acquisition unit 151 is associated, by using a region specification model for specifying region information of the speech on the basis of a speech characteristic amount. That is, the specifying unit 152 specifies the region information which is associated with the acquired speech (the units of speech of the call made by the caller) by using a region specification model which is pre-generated by the generation unit 142.

The region specification model may also be generated on the basis of various known techniques. For example, the region specification model may be generated by any learning method as long as the model specifies the region where the user is assumed to be on the basis of characteristic amounts of user utterances by the user receiving the telephone call. For instance, the region specification model specifies a region where the user is estimated to be on the basis of overall speech characteristics such as the dialect used by the user, region-specific locations (tourist attractions, landmarks, and the like), and how much names of residences, and the like, in each region are used by the user.

Furthermore, in the foregoing first embodiment, an example is described in which the information processing device 100 determines whether the speech is fraud-related speech on the basis of character string information obtained by recognizing speech as text. Here, the information processing device 100 may also perform the fraud determination by accounting for the age and gender, and so forth, of the caller. For example, the information processing device 100 performs learning by adding, to the learning data, the age and gender and so forth of the person calling, as explanatory variables. Further, the information processing device 100 learns, as a positive instance of learning data, not only character strings but also data indicated by the age and gender and so forth of a person who has actually initiated fraud. Accordingly, the information processing device 100 is capable of generating a model for determining whether speech is fraud-related speech by using, as a factor, not only a character string (conversation) characteristic but also the age and gender of the caller. Thus, the information processing device 100 is capable of making a determination that also includes attribute information of the person trying to initiate fraud (their age and gender and so forth), and hence the determination accuracy with regard to people trying to commit fraud frequently in a predetermined region, for example, can be improved. Note that attribute information such as age and gender and so forth which are associated with speech is not necessarily precise information, and attribute information which is estimated on the basis of known techniques such as speech characteristics and voiceprint analysis may also be used. Furthermore, the information processing device 100 need not necessarily perform determination processing on the basis of character string information obtained by recognizing speech as text. For example, the information processing device 100 may also acquire speech as waveform information and generate a speech determination model. In this case, the information processing device 100 acquires speech constituting a processing object as waveform information and, by inputting the acquired waveform information to the model, determines whether the acquired speech is fraud-related speech.

### 2. Second Embodiment

A second embodiment will be described next. In the foregoing first embodiment, an example was illustrated in which the information processing device 100 is a device that has a call function such as a smartphone. However, the information processing device according to the present disclosure may also be embodied so as to be used connected to a speech receiver device (a telephone such as a fixed-line telephone, for example). That is, the information processing according to the present disclosure need not necessarily be executed by the information processing device 100 alone and may instead by executed by a speech processing system 1 in which a telephone and an information processing device collaborate with each other.

This feature will be described using FIG. 15. FIG. 15 is a diagram illustrating a configuration example of a speech processing system 1 according to a second embodiment of the present disclosure. As illustrated in FIG. 15, the speech processing system 1 includes a receiver device 20 and an information processing device 100A.

The receiver device 20 is a so-called telephone that has a call function for receiving an incoming call on the basis of a corresponding telephone number and for exchanging conversations with a caller.

An information processing device 100A is a device similar to 100 according to the first embodiment but is a device without a call function in a local device (or that does not make calls using a local device). For example, the information processing device 100A may have the same configuration as the information processing device 100 illustrated in FIG. 4. The information processing device 100A may also be realized by an IC chip or the like which is incorporated in a fixed-line telephone, or the like, as per the receiver device 20, for example.

In the second embodiment, the receiver device 20 receives an incoming call from a caller. The information processing device 100A then acquires, via the receiver device 20, the speech uttered by the caller. In addition, the information processing device 100A performs determination processing with respect to the acquired speech and processing to execute actions according to the determination results. Thus, the information processing according to the present disclosure may be realized through the combination of a front-end device that is in contact with the user (in the example of FIG. 15, the receiver device 20 that performs an interaction or the like with the user) and a back-end device that performs determination processing or the like (the information processing device 100A in the example of FIG. 15). That is, the information processing according to the present disclosure can be achieved even using an embodiment with a slightly modified device configuration, and hence a user who is not using a smartphone or the like, for example, is also able to benefit from this function.

### 3. Third Embodiment

A third embodiment will be described next. In the first and second embodiments, examples are illustrated in which the information processing according to the present disclosure is executed by the information processing device 100 or the information processing device 100A. Here, some of the processing executed by the information processing device 100 or the information processing device 100A may also be performed by an external server or the like which is connected by a network.

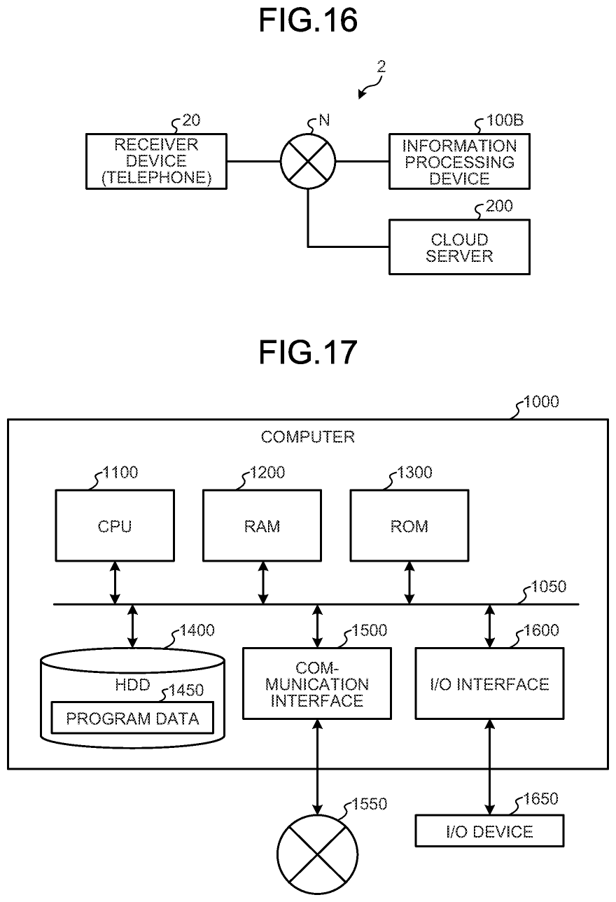

This feature will be described using FIG. 16. FIG. 16 is a diagram illustrating a configuration example of a speech processing system 2 according to a third embodiment of the present disclosure. As illustrated in FIG. 16, the speech processing system 2 includes a receiver device 20, an information processing device 100B, and a cloud server 200.

The cloud server 200 acquires speech from the receiver device 20 and the information processing device 100B and generates a speech determination model on the basis of the acquired speech. This processing corresponds to the processing of the learning processing unit 140 illustrated in FIG. 4, for example. The cloud server 200 may also acquire, via a network N, the speech acquired by the receiver device 20 and may perform determination processing on the acquired speech. This processing corresponds to the processing of the determination processing unit 150 illustrated in FIG. 4, for example. In this case, the information processing device 100B performs processing for receiving an upload of speech to the cloud server 200 and the determination result outputted by the cloud server 200 and for transmitting the upload and determination result to the receiver device 20.

Thus, the information processing according to the present disclosure may be executed through a collaboration between the receiver device 20 and the information processing device 100B and an external server such as the cloud server 200. Accordingly, even in a case where the computation functions of the receiver device 20 and information processing device 100B are inadequate, the computation function of the cloud server 200 can be used to rapidly perform the information processing according to the present disclosure.

### 4. Further Embodiments

The processing according to each of the foregoing embodiments may be carried out using various other embodiments in addition to the foregoing embodiments.

For example, the information processing according to the present disclosure can be used not only to determine telephone-based incidents such as calls but also for a so-called callout instance, or the like, in which a suspicion person calls out to a child and so forth. In this case, the information processing device 100 learns the speech of callout incidents which are trending in a certain region, for example, and generates a region-based speech determination model. Further, a user carries the information processing device 100 and starts up an app when a stranger calls out in while the user is on the go, for example. Alternatively, the information processing device 100 may automatically start up an app when speech exceeding a predetermined volume is recognized.

The information processing device 100 then makes a determination of whether the speech is similar to a callout incident or the like that has been performed in the region on the basis of the speech acquired from the stranger. Accordingly, the information processing device 100 is capable of accurately determining whether the stranger is a suspicious person.

Furthermore, in each of the foregoing embodiments, an example is illustrated in which the information processing device 100 selects the region-based model which corresponds to the region specified on the basis of the local device position information or the like. However, the information processing device 100 may not necessarily select the region-based model corresponding to the specified region.

For example, it may also be assumed that tricks relating to special fraud or the like are propagated from an urban area to a non-urban area over a predetermined period. In such cases, the information processing device 100 may, in addition to making a determination by using the region-based model corresponding to the region where the user is located, make a determination by using a plurality of region-based models which correspond to the region where the user is located as well as adjacent regions. Accordingly, the information processing device 100 is capable of accurately finding a person who has previously committed fraud in a predetermined region and who intends to commit fraud again using a similar trick in an adjacent region.

Furthermore, in each of the foregoing embodiments, an example is illustrated in which the information processing device 100 associates region information with speech on the basis of local device position information or the like, but may also associate region information on the caller side in addition to the call recipient side. For example, the caller may also be a group that performs fraudulent activities in a specific region. In such a case, region information about where the caller is located may be one factor in determining whether the speech is fraudulent. Hence, the information processing device 100 may generate a model that utilizes caller region information as one determining factor and may perform the determination by using this model. Note that the caller region information can be specified on the basis of the caller telephone number or, in the case of an IP call, an IP address or the like.

Furthermore, the information processing according to the present disclosure is capable of determining not only telephone-based incidents such as calls but also incidents involving the conversations of people actually visiting the home of the user. In this case, the information processing device 100 may be realized by a so-called smart speaker or the like which is installed in an entrance or in the home, or the like. Thus, the information processing device 100 is not limited to calls, rather, same is capable of performing determination processing on speech which is acquired in various situations.

Furthermore, the speech determination model according to the present disclosure is not limited to instances of special fraud, and may be a model for determining maliciousness of door-to-door selling or a model for determining that a patient is making a call which is out of the ordinary at a nursing facility or a hospital, or the like.

Further, among the respective processing of each of the foregoing embodiments, all or part of the processing described as being automatically performed may also be performed manually, or all or part of the processing described as being manually performed may also be performed automatically using a well-known method. Additionally, information that includes the processing procedures described in the foregoing documents and drawings, as well as specific names and various data and parameters, can be optionally changed except where special mention is made. For example, the various information illustrated in the drawings is not limited to the illustrated information.

Furthermore, various constituent elements of the respective devices illustrated are functionally conceptual and are not necessarily physically configured as per the drawings. In other words, the specific ways in which each of the devices are divided or integrated are not limited to or by those illustrated, and all or part of the devices may be functionally or physically divided or integrated using optional units according to the various loads and usage statuses, or the like.

Furthermore, the respective embodiments and modification examples described hereinabove can be suitably combined within a scope that does not contradict the processing content.

Further, the effects described in the present specification are merely intended to be illustrative and are not limited; other effects are also possible.

### 5. Hardware Configuration

The information equipment such as the information processing device 100 according to the foregoing embodiments is realized by a computer 1000 which is configured as illustrated in FIG. 17, for example. The information processing device 100 according to the first embodiment will be described hereinbelow by way of an example. FIG. 17 is a hardware configuration diagram illustrating an example of the computer 1000 that realizes the functions of the information processing device 100. The computer 1000 has a CPU 1100, a RAM 1200, a read-only memory (ROM) 1300, a hard disk drive (HDD) 1400, a communication interface 1500, and an I/O interface 1600. The parts of the computer 1000 are each connected by a bus 1050.

The CPU 1100 operates on the basis of programs which are stored in the ROM 1300 or HDD 1400, and performs control of each of the parts. For example, the CPU 1100 deploys the programs stored in the ROM 1300 or HDD 1400 in the RAM 1200 and executes processing corresponding to the various programs.

The ROM 1300 stores a boot program such as BIOS (Basic Input Output System), which is executed by the CPU 1100 when the computer 1000 starts up, and programs and the like that depend on the hardware of the computer 1000.

The HDD 1400 is a computer-readable recording medium that non-temporarily records the programs executed by the CPU 1100 as well as data and the like which is used by the programs. More specifically, the HDD 1400 is a recording medium for recording an information processing program according to the present disclosure, which is an example of program data 1450.

The communication interface 1500 is an interface for connecting the computer 1000 to an external network 1550 (the internet, for example). For example, the CPU 1100 receives data from other equipment and transmits data generated by the CPU 1100 to the other equipment, via the intermediary of the communication interface 1500.

The I/O interface 1600 is an interface for interconnecting an I/O device 1650 and the computer 1000. For example, the CPU 1100 receives data from input devices such as a keyboard or a mouse via the I/O interface 1600. Further, the CPU 1100 transmits data via the I/O interface 1600 to output devices such as a display, a loudspeaker, or a printer. In addition, the I/O interface 1600 may function as a media interface for reading programs and the like recorded on a predetermined recording medium (media). Such media are, for example, optical recording media such as a digital versatile disc (DVD) or a phase change rewritable disk (PD), a magneto-optical recording medium such as a magneto-optical disk (MO), or tape media, magnetic recording media or semiconductor memory.

For example, when the computer 1000 functions as the information processing device 100 according to the first embodiment, the CPU 1100 of the computer 1000 implements the functions of a control unit 130, or the like, by executing an information processing program which is loaded on the RAM 1200. Further, the HDD 1400 stores the information processing program according to the present disclosure and the data in the storage unit 120. Note that the CPU 1100 reads and executes the program data 1450 from the HDD 1400 and may, as another example, acquire the programs from another device via the external network 1550.

Note that the present disclosure may also adopt the following configurations.

(1)

An information processing device, comprising:

a first acquisition unit that acquires speech with which region information indicating a predetermined region and intention information indicating a caller intention are associated; and

a generation unit that generates a speech determination model for determining the intention information of speech constituting a processing object on the basis of the speech acquired by the first acquisition unit and the region information associated with the speech.

(2)

The information processing device according to (1),

wherein the first acquisition unit

acquires, as the intention information, speech with which information indicating whether a caller is attempting fraud is associated, and

the generation unit

generates a speech determination model that determines whether any speech indicates that the caller is intending to commit fraud.

(3)

The information processing device according to (1) or (2),

wherein the first acquisition unit

determines region information which is associated with the speech on the basis of position information of a receiver device that has received the speech.

(4)

The information processing device according to any one of (1) to (3),

wherein the generation unit

generates a speech determination model for each predetermined region which is associated with the speech.

(5)

An information processing device, comprising:

a second acquisition unit that acquires speech constituting a processing object;

a selection unit that selects, on the basis of region information associated with the speech acquired by the second acquisition unit, a speech determination model which corresponds to the region information from among a plurality of speech determination models; and

a determination unit that uses the speech determination model selected by the selection unit to determine intention information indicating the caller intention of the speech acquired by the second acquisition unit.

(6)

The information processing device according to (5),

wherein the selection unit

selects a speech determination model which has been learned on the basis of speech with which intention information indicating whether the caller is attempting fraud is associated, and

the determination unit

uses the speech determination model selected by the selection unit to determine whether the speech acquired by the second acquisition unit indicates an intention to commit fraud.

(7)

The information processing device according to (5) or (6), further comprising:

a specifying unit that specifies region information with which the speech acquired by the second acquisition unit is associated.

(8)

The information processing device according to any one of (5) to (7),

wherein the specifying unit specifies the region information associated with the speech acquired by the second acquisition unit, on the basis of position information of a receiver device that has received the speech.

(9)

The information processing device according to any one of (5) to (7),

wherein the specifying unit

specifies region information, with which the speech acquired by the second acquisition unit is associated, by using a region specification model for specifying region information of the speech on the basis of a speech characteristic amount.

(10)

The information processing device according to any one of (5) to (7), further comprising:

an execution unit that executes notification processing for a pre-registered registrant on the basis of the intention information determined by the determination unit.

(11)

The information processing device according to (10),

wherein the execution unit

issues, to the registrant, a predetermined notification indicating that the speech is fraud-related speech when it is determined by the determination unit that likelihood of the speech being fraud-related speech exceeds a predetermined threshold value.

(12)

The information processing device according to (10) or wherein the execution unit (11),

notifies the registrant of a character string constituting

a result of subjecting the speech to speech recognition.

(13)

The information processing device according to any one of (5) to (12),

wherein the second acquisition unit

checks caller information of the speech against a list indicating whether a caller is suitable as a speech caller, and acquires, as speech constituting the processing object, only speech uttered by a caller deemed suitable as a speech caller.

(14)

The information processing device according to any one of (5) to (13),

wherein the selection unit

selects a first speech determination model on the basis of the region information and selects a second speech determination model which differs from the first speech determination model, and

the determination unit

uses the first speech determination model and the second speech determination model, respectively, to determine intention information indicating the caller intention of the speech acquired by the second acquisition unit.

(15)

The information processing device according to (14),

wherein the determination unit

uses the first speech determination model and the second speech determination model, respectively, to calculate scores indicating likelihood of the speech being fraud-related speech, and determines, on the basis of the score indicating a higher likelihood of the speech being fraud-related speech, whether the speech is fraud-related speech.

(16)

An information processing method, by a computer, comprising:

acquiring speech with which region information indicating a predetermined region and intention information indicating a caller intention are associated; and

generating a speech determination model for determining the intention information of speech constituting a processing object on the basis of the acquired speech and the region information associated with the speech.

(17)

An information processing program for causing a computer to function as:

a first acquisition unit that acquires speech with which region information indicating a predetermined region and intention information indicating a caller intention are associated; and

a generation unit that generates a speech determination model for determining the intention information of speech constituting a processing object on the basis of the speech acquired by the first acquisition unit and the region information associated with the speech.

(18)

An information processing method, by a computer, comprising:

acquiring speech constituting a processing object;

selecting, on the basis of region information associated with the acquired speech, a speech determination model which corresponds to the region information from among a plurality of speech determination models; and

using the selected speech determination model to determine intention information indicating a caller intention of the acquired speech.

(19)

An information processing program for causing a computer to function as:

a second acquisition unit that acquires speech constituting a processing object;

a selection unit that selects, on the basis of region information associated with the speech acquired by the second acquisition unit, a speech determination model which corresponds to the region information from among a plurality of speech determination models; and

a determination unit that uses the speech determination model selected by the selection unit to determine intention information indicating a caller intention of the speech acquired by the second acquisition unit.

### REFERENCE SIGNS LIST

1, 2 SPEECH PROCESSING SYSTEM
100, 100A, 100B INFORMATION PROCESSING DEVICE
110 COMMUNICATIONS UNIT
120 STORAGE UNIT
121 LEARNING DATA STORAGE UNIT
122 REGION-BASED MODEL STORAGE UNIT
123 COMMON MODEL STORAGE UNIT
124 UNWANTED TELEPHONE NUMBER STORAGE UNIT
125 ACTION INFORMATION STORAGE UNIT
130 CONTROL UNIT
140 LEARNING PROCESSING UNIT
141 FIRST ACQUISITION UNIT
142 GENERATION UNIT
143 REGION-BASED MODEL GENERATION UNIT
144 COMMON MODEL GENERATION UNIT
150 DETERMINATION PROCESSING UNIT
151 SECOND ACQUISITION UNIT
152 SPECIFYING UNIT
153 SELECTION UNIT
154 DETERMINATION UNIT
155 ACTION PROCESSING UNIT
156 REGISTRATION UNIT
157 EXECUTION UNIT
RECEIVER DEVICE
200 CLOUD SERVER
1000 COMPUTER
1050 BUS
1100 CPU
1200 RAM
1300 ROM
1400 HDD
1450 PROGRAM DATA
1500 COMMUNICATION INTERFACE
1550 EXTERNAL NETWORK
1600 I/O INTERFACE
1650 I/O DEVICE

1. An information processing device, comprising:
a first acquisition unit that acquires speech with which region information indicating a predetermined region and intention information indicating a caller intention are associated; and
a generation unit that generates a speech determination model for determining the intention information of speech constituting a processing object on the basis of the speech acquired by the first acquisition unit and the region information associated with the speech.

2. The information processing device according to claim 1,
wherein the first acquisition unit
acquires, as the intention information, speech with which information indicating whether a caller is attempting fraud is associated, and
the generation unit
generates a speech determination model that determines whether any speech indicates that the caller is intending to commit fraud.

3. The information processing device according to claim 1,
wherein the first acquisition unit
determines region information which is associated with the speech on the basis of position information of a receiver device that has received the speech.

4. The information processing device according to claim 1,
wherein the generation unit
generates a speech determination model for each predetermined region which is associated with the speech.

5. An information processing device, comprising:
a second acquisition unit that acquires speech constituting a processing object;
a selection unit that selects, on the basis of region information associated with the speech acquired by the second acquisition unit, a speech determination model which corresponds to the region information from among a plurality of speech determination models; and
a determination unit that uses the speech determination model selected by the selection unit to determine intention information indicating the caller intention of the speech acquired by the second acquisition unit.

6. The information processing device according to claim 5,
wherein the selection unit
selects a speech determination model which has been learned on the basis of speech with which intention information indicating whether the caller is attempting fraud is associated, and
the determination unit
uses the speech determination model selected by the selection unit to determine whether the speech acquired by the second acquisition unit indicates an intention to commit fraud.

7. The information processing device according to claim 5, further comprising:
a specifying unit that specifies region information with which the speech acquired by the second acquisition unit is associated.

8. The information processing device according to claim 7,
wherein the specifying unit specifies the region information associated with the speech acquired by the second acquisition unit, on the basis of position information of a receiver device that has received the speech.

9. The information processing device according to claim 7,
wherein the specifying unit
specifies region information, with which the speech acquired by the second acquisition unit is associated, by using a region specification model for specifying region information of the speech on the basis of a speech characteristic amount.

10. The information processing device according to claim 5, further comprising:
an execution unit that executes notification processing for a pre-registered registrant on the basis of the intention information determined by the determination unit.

11. The information processing device according to claim 10,
wherein the execution unit
issues, to the registrant, a predetermined notification indicating that the speech is fraud-related speech when it is determined by the determination unit that likelihood of the speech being fraud-related speech exceeds a predetermined threshold value.

12. The information processing device according to claim 10,
wherein the execution unit
notifies the registrant of a character string constituting a result of subjecting the speech to speech recognition.

13. The information processing device according to claim 5,
wherein the second acquisition unit
checks caller information of the speech against a list indicating whether a caller is suitable as a speech caller, and acquires, as speech constituting the processing object, only speech uttered by a caller deemed suitable as a speech caller.

14. The information processing device according to claim 5,
wherein the selection unit
selects a first speech determination model on the basis of the region information and selects a second speech determination model which differs from the first speech determination model, and
the determination unit
uses the first speech determination model and the second speech determination model, respectively, to determine intention information indicating the caller intention of the speech acquired by the second acquisition unit.

15. The information processing device according to claim 14,
wherein the determination unit
uses the first speech determination model and the second speech determination model, respectively, to calculate scores indicating likelihood of the speech being fraud-related speech, and determines, on the basis of the score indicating a higher likelihood of the speech being fraud-related speech, whether the speech is fraud-related speech.

16. An information processing method, by a computer, comprising:
acquiring speech with which region information indicating a predetermined region and intention information indicating a caller intention are associated; and
generating a speech determination model for determining the intention information of speech constituting a processing object on the basis of the acquired speech and the region information associated with the speech.

17. An information processing program for causing a computer to function as:
a first acquisition unit that acquires speech with which region information indicating a predetermined region and intention information indicating a caller intention are associated; and
a generation unit that generates a speech determination model for determining the intention information of speech constituting a processing object on the basis of the speech acquired by the first acquisition unit and the region information associated with the speech.

18. An information processing method, by a computer, comprising:
acquiring speech constituting a processing object;
selecting, on the basis of region information associated with the acquired speech, a speech determination model which corresponds to the region information from among a plurality of speech determination models; and
using the selected speech determination model to determine intention information indicating a caller intention of the acquired speech.

19. An information processing program for causing a computer to function as:
a second acquisition unit that acquires speech constituting a processing object;
a selection unit that selects, on the basis of region information associated with the speech acquired by the second acquisition unit, a speech determination model which corresponds to the region information from among a plurality of speech determination models; and
a determination unit that uses the speech determination model selected by the selection unit to determine intention information indicating a caller intention of the speech acquired by the second acquisition unit.
